(19) United States
(12) Patent Application Publication
(10) Pub. No.: US 2005/0246583 A1
(43) Pub. Date: Nov. 3, 2005

(54) Automatic backup system

(76) Inventor: Eric Robinson, Mission Viejo, CA (US)

Correspondence Address: WILLIAM G. LANE;WILLIAM G. LANE, INC., PC, 16485 LAGUNA CANYON RD, SUITE 250, IRVINE, CA, 92618, US

(21) Appl. No.: 11/150,782

(22) Filed: Jun. 10, 2005

Related U.S. Application Data
(63) Continuation of application No. 10/222,004, filed on Aug. 14, 2002, now abandoned.
Application No. 10/222,004 is a continuation of application No. 09/416,675, filed on Oct. 12, 1999.

(51) Int. Cl. G06F 11/00

(52) U.S. Cl. 714/15

(57) ABSTRACT

A method of automatically backing up a computer with an external hard drive, combined with a PCMCIA card, comprising connecting the combination of external hard drive and PCMCIA card into the PCMCIA port of a computer, the CPU of the computer scanning, detecting and identifying the external hard drive, the CPU automatically launching the backup procedure to backup the computer source drive onto the external hard drive without operator intervention; and the CPU automatically quitting the backup when the backup is complete without operator intervention.

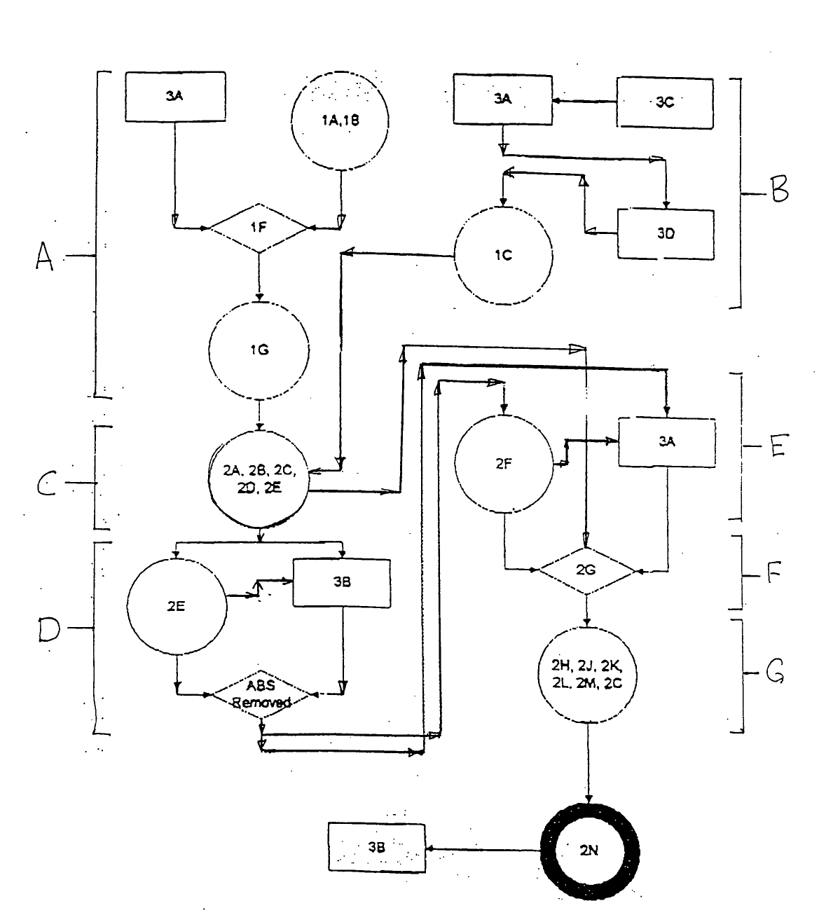

### FIELD OF THE INVENTION

The present invention is directed an external storage automatic backup system for a computer.

### BACKGROUND OF THE INVENTION

The backup of computer data is an essential operation for any computer. The backup of computer data to another storage medium or storage device has been known since the earliest days of the electronic computer. In the 1980's when the hard drives had not yet reached the gigabyte size, most backups of the personal computer were made directly to floppy disks such as the 3 1/2 inch and the 5 1/4 inch disk. It was recognized early on that floppys only had limited utilization because of capacity limitations. They were initially limited to a capacity of around 360 kilobytes, later expanded to 1.44 kilobytes. When the hard drive was storing 40 or more megabytes of data, floppy disks were inconvenient and time consuming for backup. At that stage, the tape backup became more prevalent. The tape backup is an internal unit or an external unit with a removable tape cartridge. The original tapes only could store a minimum amount of information. Today, the tapes can store 800 megabytes or more of information. Although the tape backup can store a great deal of information, they are slow to backup and restore. In order to bridge the data limitations of floppy disks and overcome the slow speeds of the tape backup, the ZIP disk drives were developed whereby relatively large amounts of information, 100 megabytes or more could be quickly backed up and quickly restored. The ZIP drives are being surpassed by the JAZ drives which are equally as fast and yet store more information. For computers that are networked, such as with a LAN system, the server can not only function as a main data storage, but also as backup data storage. This is normally accomplished with a second hard drive or with one or more tape drives. With the size of hard drives increasing dramatically, hard drives of over 20 gigabytes are now available, and the price of the hard drive dropping equally dramatically, the hard drive is becoming an attractive backup device. Computers are being constructed with two hard drives. The first hard drive functions as the main memory storage and the second hard drive functions as the backup storage device. Although the system has merit, it is not perfect. For example, destruction of the computer itself destroys both the primary hard drive and the backup hard drive. Power surges can knock out both hard drives. Thus, in these situations, there is no backup. Ideally, the backup memory device is stored external to the computer. This not only permits the operator to backup the data and physically separate the backup storage device from the computer so that harm to one will not harm the other. Removable hard drives are available for desktop computers. They are not available for laptop computers and notebooks because of size and space restrictions.

Except for the tape drive, most backup systems require instructions from the operator. The tape drive can be programmed so that backup takes place automatically at preset hours. This requires no intervention of the operator, when all the backup options have been set up on the backup program. Tape backup is normally conducted during off business hours because of the tape's slow speed. Since the tape cannot be removed or replaced until the next business or user time, destruction of the computer will destroy the tape. Also during the off business hours, the tape can be stolen or copied.

Many computers, such as the notebooks and the laptop computers, do not have sufficient internal space to include an additional hard drive or to include a tape drive. In fact, most notebooks and laptops available today do not even have a floppy drive. These computers must be physically hooked up to a device to backup the information on the hard drive. If the backup operation is not carried out on a routine basis, and the computer is lost, stolen, or destroyed, the operator has no backup. Because their size and portability, the theft rate for laptops and notebooks is much greater than for desk tops.

Ideally, the backup system would be an external backup storage device that could be quickly and easily attached to the computer, which would automatically backup the computer main memory with no intervention or a minimum intervention from the operator, which is portable, which has a large capacity and which backs up and restores quickly. Ideally, the backup device would be inserted into or connected to the computer, the computer would detect the device, commence the backup operation, employ the preset backup options set by the operator and complete the backup operation without any further intervention of the operator. The operator would then remove the backup device from the computer and store it in a location remote from the computer or transport the backup device to install the data into another computer or computer system. A convenient backup device would be an external hard drive that can be connected to a computer port, such as a PCMCIA port. The backup device would draw the necessary power from the computer and could boot up the necessary operating software into the computer to carry out the automatic backup operation. Alternatively, the computer can be preprogrammed with the backup operating software to carryout the backup operation. The backup operation system can employ known operating software to carry out the automatic backup procedure.

### SUMMARY OF THE INVENTION

The present invention is directed to an automatic backup system comprising the steps of:
inserting an automatic back up system into the port of a computer;
the computer scanning and detecting a device connected to the port;
the computer identifying the automatic backup system;
the computer automatically launching a backup procedure to backup its files onto the automatic backup system; and
the computer automatically closing down the backup procedure at the completion of the backup.

The present invention is also directed to a method of automatically backing up data from a computer employing an automatic backup system (“ABS” herein). The method comprising:
connecting an automatic backup device comprising a combination of a hard drive and PCMCIA card (the “ABS unit” herein) to a PCMCIA port on a computer;
the computer CPU, i.e. central processing unit, scanning for devices connected to its PCMCIA port;
the CPU recognizing the ABS unit inserted into the PCMCIA port; the CPU launching an automatic backup procedure comprising:
the CPU scanning all files on the computer source drives and comparing these files to the files on the ABS unit for date and time changes to identify file changes and new files on the computer service drive;
the CPU comparing the space available on the ABS unit to the space required to back up file changes and new files from the computer source drives to the ABS unit;
the CPU making a file-by-file transfer of the file changes and new files to the ABS unit if the computer finds sufficient available space on the ABS unit; or
the computer reporting insufficient available space and not initiating the file-by-file transfer of file changes and new files to the ABS unit when the CPU finds insufficient available space on the ABS unit.

Optionally, the CPU can report the status of backup at the end of the file-by-file transfer to the ABS unit on the computer monitor.

Optionally, the CPU can write to the backup file on the source drive the status of the file-by-file transfer to the ABS unit and/or the backup.exe file on the computer source drives at the end of the automatic backup.

Optionally, the CPU can review the status of the file-by-file transfer of the previous backup on the backup.exe file on the source drive prior to scanning, or when it scans, all files on the source drive to identify file changes and new files.

Optionally, the CPU automatically terminates the automatic backup procedure after CPU writes the status of the file-by-file transfer to the ABS unit.

Optionally, the CPU requests selection of options to launch backup prior to the CPU scanning all files on the source drive. When the backup options have been selected, the CPU automatically commences the backup procedure.

Optionally, the CPU can scan the computer registry for automatic backup launch when the CPU recognizes the ABS unit connected to its PCMCIA port.

Optionally, the CPU can request a password after connection of the ABS unit to the computer's PCMCIA port, upon entry of a password into the computer, the CPU translates the password from the computer registry and compares it to the entered password and the CPU transfers the password to the ABS unit connected to its PCMCIA port and compares the entered password to the password from the computer registry to determine if the entered password is correct. The ABS unit can optionally compare the password in its registry to the CPU transferred password. Upon the CPU verifying the authenticity of the entered password, the CPU commences to launch the automatic backup procedure. When the ABS unit authenticates the CPU transferred password it authorizes entry of the CPU into its files.

Optionally, the CPU can request a password; when a password is entered into the computer; the CPU translates the password from its registry; and the computer transfers the entered password to the ABS unit connected to its PCMCIA port.

After the CPU recognizes the ABS unit connected to the PCMCIA port, it can request a password from the ABS unit. When the ABS unit furnishes the password to the CPU; the CPU translates the password from the registry; and the CPU compares and authenticates the ABS unit password prior to launching the backup procedure.

Optionally, the CPU can request a selection of options after it recognizes the ABS unit connected to the PCMCIA port and before launching the backup procedure. Alternatively, the CPU can scan the computer registry for preselected options prior to launching the backup procedure.

If the passwords entered at the CPU's request cannot authenticated, the CPU can monitor for a retry or quit program option and/or request removal of the ABS unit from the PCMCIA port.

If the ABS unit is disconnected from the computer PCMCIA port prior to completion of the file-by-file transfer; the CPU will detect the disconnection request or monitor that the ABS unit be connected to the computer PCMCIA port.

If the CPU determines that the ABS unit has insufficient space available to make the file-by-file transfer, the CPU reports that there is insufficient space and will not initiate the backup procedure. The CPU can monitor to overwrite all files on the ABS unit if the ABS unit has sufficient space for a full file-by-file transfer from the computer source drives or monitor from removal of the ABS unit and shut down the automatic backup procedure.

The ABS unit can be a PCMCIA/PC-Card interface permanently attached to a hard drive in an enclosure external of the computer by a flat flexible cable.

The automatic backup system can be installed in a computer, such as a computer with a Windows operating system by inserting the PC-Card into the computer, such as a notebook, and loading the standard Windows PCMCIA card drivers: the automatic backup system setup program then launches itself. The installation requires a single reboot to install Vxd drivers. On completion of the reboot, express or custom install options can be presented. The express option, the preferred option, will set up a backup of the complete C:/drive to the ABS unit. A custom installation allows the user to select drives, folders or file types and to select backup paths. The ABS unit looks like a hard drive to the system, and a typical path would be “E:\Backup of Drive D\”., with source drive being the D Drive. The custom setting also allows the user to set the configuration verify, automatic launch on the PCMCIA insertion, password protected backup and unattended backup which powers down the computer on completion of backup, i.e. the backup procedure. In another option, the custom setting allows selection or enabling selection of file exceptions, through a browse function and to select a list option which forces a compare of the ABS against the source and listing the first N differences; N can be any number such as 2000. This option requires operator intervention to approve each backup and permits or enables files to be restored straight from the list.

The Launcher Menu items for custom settings can include: (1) Launch Backup, i.e. the backup procedure, (2) Launch Backup/Compare, i.e. the backup procedure with step of comparing the source drive files and folders with the ABS unit files and folders for time and date changes, including new files and folders, (3) Backup Settings for passwords protocols or changes, backup procedure options, and the like, (4) Password Administrator, and/or (5) Disable ABS Launcher, i.e. disable the backup procedure to restore to the host computer or to copy the backup files to a second computer.

### BRIEF DESCRIPTION OF THE DRAWINGS

This FIGURE is a schematic flow diagram of the automatic backup system of the present invention.

### DETAILED DESCRIPTION OF THE INVENTION

The invention comprises a method of automatically backing up a computer with an external hard drive, combined with a PCMCIA card, comprising connecting the combination of external hard drive and PCMCIA card into the PCMCIA port of a computer, the CPU of the computer scanning, detecting and identifying the external hard drive, the CPU automatically launching the backup procedure to backup the computer source drive onto the external hard drive without operator intervention; and the CPU automatically quitting the backup when the backup is complete without operator intervention.

The operating programs on virtually all personal computers, i.e. personal computers, i.e. desktop, laptop and notebook computers, instruct the computer's CPU to scan various components of the computer on a periodic basis to determine the operating status of the component and/or determine if the computer is connected to an external device. These operations include scanning the PCMCIA port, parallel port, serial port, USB port, floppy drive, CD-ROM drive, and the like. When the computer detects a device connected to one of its ports, it addresses the device for identification purposes. External devices that have been configured for the computer will be recognized. When the CPU identifies an external device not configured for the computer or cannot identify the device, it will inform or monitor the operator on the computer monitor, this is often referred to as “monitoring” the operator or user, that an unknown device is connect to the port.

CMS Peripherals, of Costa Mesa, Calif., has developed a PCMCIA card, which can be detachably connected to a replacement hard drive for a laptop computer. The combination is inserted into the PCMCIA port of a laptop computer to copy the data from the source drives of the computer to the replacement hard drive. After the data has been transferred, the replacement hard drive is disconnected from the PCMCIA card, the existing source drives in the laptop computer are removed from the computer and the replacement hard drive is substituted in their place. The data transfer is made so that the replacement hard drive can be installed directly into the computer to yield a fully operational computer with all its files and programs fully available when the replacement hard drive is installed. This operation has been found to make the upgrading of the source drives on a laptop computer easy and convenient. The copying of data from the existing hard drive to the replacement hard drive is not an automatic operation and requires instructions and commands from the computer operator.

In the present invention, an external hard drive is used as a backup device. The external hard drive is combined with a PCMCIA card, programmed for backing up and restoration of data on one or more computers. The necessary operating or backup software to carry out this operation can be placed in the flash memory of the backup hard drive or on the resident memory of the backup hard drive. The necessary backup software can also be on a floppy disk or a CD ROM and can be installed in the host computer in order to carry out the automatic backup procedure.

The automatic backup system comprises a number of steps, which are initiated when an automatic backup system unit (“ABS unit” herein) is inserted into the PCMCIA port of a computer, block 3A of the drawing. The operating programs of most computers command the computer CPU to scan the computer ports to detected external devices connected to the various computer ports. Alternatively, an executable program can be installed on the computer, herein referred to as the “launcher.exe file”, which will command the CPU of the computer to scan for detection of insertion of an ABS unit into the PCMCIA port, block 1A on the drawing. The launcher.exe program will also command the CPU to scan the computer registry for the elected and default options of the automatic backup system. The default options will be for automatic backup (hereinafter referred to as “auto-launch option”), block 1B in the drawing. If the CPU block recognizes the ABS unit connected to the computer's PCMCIA port, block 1F in the drawing, the CPU of the computer will launch the automatic backup procedure.

The automatic backup procedure will be carried out by an executable file, herein referred to as “backup.exe file,” block 1G in the drawing. If the default setting for the auto-launch option has been disabled, and the ABS unit is inserted into the computer's PCMCIA port, the computer CPU will request or monitor the operator to select a menu option from the launcher.exe file (blocks 3C, 3A and 3D, respectively, in the drawing). If the automatic backup option is manually selected from the launcher.exe file, the CPU will launch the automatic backup procedure, block 1C in the drawing. The difference between steps of block 1G and 1C is that step of block 1G is an automatic launch of the automatic backup procedure, whereas, the step of block 1C is an operator-instructed launching of the backup procedure.

The automatic backup procedure at stage C of the drawing comprises a series of sequential steps. The CPU scans the computer registry for backup option default selections if no selections have been made. The default selections instruct the CPU to scan all files on the computer source drive and compare the files to the file on the ABS unit for date and time changes. The CPU identifies the file changes on the source drives that are not on the ABS unit and compares space requirement for the file changes on the source drive to the space available on the ABS unit to determine if the ABS unit has sufficient space to backup the file changes. If the ABS has insufficient space, the CPU reports or monitors that there is insufficient space available for backup. If sufficient space is available, the CPU automatically performs a file-by-file transfer of file changes to the ABS unit. When the file-by-file transfer of the file changes has been completed, the CPU reports or monitors the status of the backup at the end of the backup, which advises the operator of those files that could not be backed up or whether the backup was completed successfully. The CPU writes the status of a successful backup to the backup.exe file on the source drives for reference when the next automatic backup operation is to be carried out. On the completion of this step, the CPU terminates the automatic backup procedure. When one or more files cannot be backed up, the CPU monitors an option menu giving the operator the option of completing the backup without the identified file changes, quitting the automatic backup, or retrying the backup, or backing up the external source drive.

Preferably, the automatic backup procedure will require a password to prevent unauthorized access to the computer data and/or to prevent access to the backup data on the ABS unit. The password protocol can either occur prior to initiation of the automatic backup procedure or at the commencement of the backup procedure. In one embodiment, the CPU, after connection of the ABS unit to the PCMCIA port of the computer and recognition of the ABS unit by the CPU, will request or monitor the operator for a password. This can also occur after the CPU recognizes the connect to ABS and at the commencement of the automatic backup procedure. The password will be entered via the keyboard into the computer. The CPU of the computer will translate the password from the computer registry and transfer the password to the ABS unit via the PCMCIA port. The CPU will compare the operator-entered password with the password from the registry and only proceed to the next step of the automatic backup system in the event the passwords match and the entered password is authenticated. In the event the passwords do not match, the CPU will monitor the password error and request a reentry of the password. It will also send a signal to the ABS unit, notifying the ABS unit of a password error. Optionally, the CPU can send a signal to the computer source drive, advising them of the password error. If the password is entered incorrectly, the second time, the CPU repeats the above steps. The ABS unit flash memory and a source drive's flash memory can be programmed to destroy their stored data by reformatting after the entry of a set number of incorrect passwords. This command will normally not be initiated within the flash memory of the source drive and the ABS unit hard drive until three or four passwords errors have been sequentially made. In some instances, the command will be made upon the entry of two incorrect passwords.

To prevent the skilled computer hacker from bypassing this password protection system, the CPU will write into the resident memory of the ABS unit hard drive, and optionally, to the computer source drives, a reformat command which is activated upon a set number of the sequential password errors, the “even number” herein. If the correct password is entered before the event number is reached, that is, the preset number of sequential password errors that will initiate the command from the flash memory of the ABS unit hard drive and/or the source drives to reformat the drives, the CPU will send a signal to the ABS unit and, optionally, to the source drives, advising the entry of the correct password and authentication of the password. This signal or information will overwrite the count data on the sequential entry of the password errors. Thus, if a hacker knows that particular computer has been programmed to reformat the source drive and the ABS unit hard drive upon the attempted entry of four erroneous passwords, and the hacker attempts to avoid this event number by disconnecting the ABS unit from the PCMCIA port and/or by shutting down the computer after the entry in N-1 erroneous passwords wherein N is the preset event number. The ABS unit will keep count and optionally the source drives will keep count of the number of sequentially entered erroneous passwords since the last successful password entry identification. Even it the ABS unit is disconnected from the PCMCIA port after commencement of the reformat of the ABS unit hard drive, this will not prevent reformatting of the ABS unit hard drive. Once, the hard drive is connected to a PCMCIA port of any computer, the only command that the ABS unit will recognize is to reformat the hard drive until such time as that step is completed. Similarly, when the computer is powered up, the only command the source drives will recognize is the reformat command until reformatting is complete. Even the disassembly of a hard drive and removal of the disks from the hard drive and reinsertion into a new hard drive chassis will not avoid the reformatting command which is embedded in the flash memory on the disk.

Because password protection can result in the total elimination of all stored data, the security-conscious computer user will preferably have two ABS units which will not be stored in the same location and will not be stored with the host computers. Thus, if the computer hacker is able to gain access to one of the ABS units and a host computer, and incorrectly enters incorrect password the event number of times, causing the source drive of the computer and the hard drive of the ABS unit to reformat, destroying all data, the legitimate computer user will be able to restore the data onto the host computer, using the second ABS unit. The first ABS unit, which has been reformatted, can be reused.

In another option, when the CPU detects the connection of the ABS unit to the PCMCIA port, as part of the recognition protocol, the CPU can request a password from the ABS unit. The CPU translates the password from the computer registry and the ABS unit enters a password from its flash memory via the PCMCIA port up to the CPU. The CPU compares the password from the registry with the ABS unit entered password, and if they are identical, the CPU authenticates the ABS unit and password and proceeds with the automatic backup procedure described above. If the CPU, on comparison of the password of the registry and ABS unit passwords, finds they are not the same, the CPU will request or monitor the removal of the ABS unit and monitor that there has been a password error from the ABS unit and/or that the computer did not recognize the ABS unit. As an option, the CPU can monitor an option menu, giving the operator the opportunity to override this particular password protection and command the automatic backup procedure to commence. Preferably, the CPU will request a password from the operator, which can be the correct password for the ABS unit, to initiate the backup procedure in the event that the CPU cannot authenticate the ABS unit password. The CPU will translate the password from the computer registry and compare the password entered by the operator. If the passwords are identical, it will authenticate the operator password and initiate the automatic backup procedure. Optionally, before initiating the automatic backup procedure, the CPU can menu options to the operator, permitting the operator to change the password on the ABS unit, which password will be entered in flash memory or resident memory of the ABS unit hard drive and in the computer registry for future automatic backup procedures.

At stage D of the automatic backup procedure, D of the drawing, in the event that certain events described above occur, the ABS unit can be removed or disconnected from the PCMCIA port. If the operator disconnects the ABS unit from the PCMCIA port, pursuant to the CPU monitoring for the removal of the ABS unit, block 2E of the drawing, the operator, on his own volition for one reason or another, can remove the ABS unit from the PCMCIA port, block 3B of the drawing. If the automatic backup procedure has not been completed, the CPU continues to monitor for insertion of the ABS unit into the PCMCIA port, block 2F of the drawing. If the CPU has monitored for removal of the ABS unit and detects connection of the ABS unit from the PCMCIA port, the automatic backup procedure will be automatically commenced. In that event, if the operator wishes to initiate the automatic backup procedure, the operator must insert the ABS unit into the PCMCIA port and commence the sequence of the steps described above. If the operator removes the ABS unit from the PCMCIA port, without being monitored by the CPU, the automatic backup procedure will not be closed down. Upon reinsertion of the ABS unit under such circumstances, the automatic backup procedure will continue, blocks 2F and 3A of the drawing.

Stage F of the procedure can proceed directly from stage C or stages D and E; C, D, E, and F of the drawing. At stage F, the ABS unit is connected to the PCMCIA port, and has been identified by the CPU, all the password protection events have been satisfied, and CPU pursuant to the automatic backup procedure, scans all the files on the source drive, compares them to the files on the ABS unit for date and time changes and for files missing on the ABS unit, block 2G of the drawing. Proceeding to stage G, G of the drawings, the CPU compares the space required to backup file changes and new files with the space available on the ABS unit, block 2H of the drawing.

If the CPU finds that there is insufficient space available on the ABS unit to backup file changes and the new files on the source drives, it reports or monitors insufficient space available, giving the operator the opportunity to quit the automatic backup procedure or insert another ABS unit having sufficient space. If the operator removes the ABS unit from the PCMCIA port, the CPU, on detecting the removal of the ABS unit, will monitor to replace the ABS unit with an ABS unit with sufficient space or to quit the automatic backup procedure program. If another ABS unit is connected to the PCMCIA port, the CPU scans and compares the files, block 2G of the drawing, compares the space availability on the replacement ABS unit, block 2H of the drawing, and again monitors the operator if there is insufficient space available. If the CPU finds there is sufficient space available for the ABS unit to back up file changes and new files of the source drive of the computer, the CPU performs a file-by-file transfer of changed files and new files onto the ABS unit. In order to save time for the backup procedure, the default step will be to make a file-by-file transfer to backup file changes and new files, block 2K of the drawing. However, when the automatic procedure program is initially set up, the operator has the option of selecting a complete backup of all files, including unchanged files, file changes, and new files at each automatic back operation. In order to maximize space availability on the ABS unit, this latter option can include a scan disk and/or defrag disk operation. There are known operations and can be carried out with the operating program of virtually all computers. At the end of the backup, either a partial backup or a full backup, the CPU reports the status of the backup. If the backup is successful and all the file changes and new files were backed up on a partial backup, or if all the files including unchanged files, changed files, and new files were backed up in a full backup, the CPU reports or monitors successful completed backup, block 2L of drawing. Optionally, the menu can report the files backed up, the total amount of space available on the ABS unit, the amount off space occupied, and the amount of free space for future backup, block 2L of the drawing. The CPU then writes a status report to the files on the source drive referred to the backup.log file for future reference for the backup, block 2M of the drawing. The automatic backup procedure then automatically terminates the backup which can be conveniently reported on the monitor by a menu reporting successful completion of backup and termination of the same, block 2N of the drawing. Optionally, the operator can be given option selections to quit the program, redo the backup, either in a partial backup or full backup or the like, block 2N drawing. Upon completion of the backup, the operator removes the ABS unit from the PCMCIA port and can either store the ABS unit at a location remote from the computer to prevent simultaneous damage of the computer and backup data or can use the ABS unit as a transport unit to transfer the data from the host computer to a second computer. This is very convenient for those who have two or more offices. When there is a non-network system of two or more computers at separate locations, the operator, at the conclusion of each business day, can quickly back up the computer he or she is operating on an ABS unit. The ABS unit, which is quite small, can be transported to their other office and the data from the first host computer or data changes can be installed on to a second host computer by a restoration step or copy step. When the operator goes back to the first office with the first host computer, all the file changes and new files on the second host computer can be backed up on the ABS unit and the ABS unit can be used to update the first host computer with the file changes and new files of the second host computer via a restoration step, or copy step. This procedure does not really require a second ABS unit since for backup, the first computer and second computers both function as remote backup sources. The use of the ABS unit to transfer information from one computer to another computer is very secure because the data is not capable of being intercepted unless the ABS unit is stolen.

One of the most advantageous benefits of the automatic backup procedure is the fact that the procedure is totally automatic once the selection of default options is made. The procedure requires no intervention by the operator other than inserting the ABS unit into the PCMCIA port of the computer and removing it when completion of the backup is monitored. This backup procedure can be utilized during the operation of the computer functions. At the close of each business day, or when the operator returns from a business trip, the operator can quickly and effortlessly backup the data on the computer. Hard drive backup system is far faster than a tape backup system and has several magnitudes of more space available than the current zip and zap drives.

The software programs of the present system can use a combination of known software to carry out the individual steps of the ABS.

1. A method of automatically backing up data from a computer comprising:
connecting an ABS unit to a PCMCIA port on a computer;
the computer scanning for devices connected to its PCMCIA port;
the computer recognizing the ABS unit inserted into its PCMCIA port;
the computer launching its automatic backup procedure;
the computer scanning all files on its source drives and comparing the files on the ABS unit for date and time changes;
the computer comparing space available on the ABS unit and comparing it to the space required to back up file changes on the source drive in the computer; and
the computer making a file-by-file transfer the file changes to the ABS unit; if the computer finds enough space available on the ABS unit.

2. The method according to claim 1 wherein the computer reports status of backup at the end of the file-by-file transfer to the ABS unit.

3. The method according to claim 1 wherein the computer writes the status of the file-by-file transfer to the ABS unit at the end of backup to the source drives.

4. The method according to claim 3 wherein the computer reviews the status of the file-by-file transfer at the end of the last backup when it scans all files on the source drives and compares the files on the ABS unit for date and time changes.

5. The method according to claim 3 wherein the computer terminates the backup after completion of writing the status of the file-by-file transfer to the ABS unit at the completion of the backup.

6. The method according to claim 1 wherein the computer offers an operator of the computer a manual option to launch backup prior to the computer scanning all files on the source drive.

7. The method according to claim 6 wherein the operator manually selects backup and the computer automatically commences the backup procedure.

8. The method according to claim 1 wherein the computer scans its registry for an automatic backup launch file when the computer recognizes the ABS unit connected to its PCMCIA port.

9. The method according to claim 1 wherein the computer requests a password after connection of the ABS unit to the computer's PCMCIA port; a password is entered into the computer, the computer translates the backup procedure password from the registry and compares it to the entered password and the computer transfers passwords to the ABS unit connected to its PCMCIA port wherein the ABS unit compares password in its registry to the entered password; and upon the computer verifying the authenticity of the entered password, the computer to launches the backup procedure, and when the ABS unit authenticates the operator-entered password authorizes entry of the computer into its files.

10. The method according to claim 1 wherein the computer requests a password; a password is entered into the computer; the computer translates the password from its registry; and the computer transfers the operator-entered password to the ABS unit connected to its PCMCIA port.

11. The method according to claim 1 wherein the computer after recognizing the ABS unit connected to its PCMCIA port and requests a password from the ABS unit; the ABS unit furnishes the password to the computer; the computer translates the password from the registry; and the computer authenticates the password prior to launching the backup procedure.

12. The method according to claim 1 wherein the computer requests the operator for a selection of options after the computer recognizes the ABS unit connected to its PCMCIA port and before launching the backup procedure.

13. The method according to claim 1 wherein the computer scans its registry for option selections prior to launching the backup procedure.

14. The method according to claim 1 wherein the computer requests removal of the ABS unit from its PCMCIA port.

15. The method according to claim 14 wherein the computer requests insertion of the ABS unit to its PCMCIA port.

16. The method according to claim 1 wherein the ABS unit is disconnected from the computer PCMCIA port prior to completion of the file-by-file transfer; and the computer requests connection of the ABS unit to its PCMCIA port.

17. The method according to claim 1 wherein the computer compares the space available on the ABS unit to the file changes on the source drives and finds there is insufficient space available to backup the file changes and monitors that there insufficient available space on the ABS unit to complete the backup procedure.

18. The method according to claim 17 wherein the ABS unit is removed from the PCMCIA port, and replaced with a new ABS unit having sufficient available space to backup the computer source drives.

19. The method according to claim 17 wherein the computer shuts down the backup procedure when it finds there is insufficient available space to complete the backup procedure.

20. An automatic backup system comprising the steps of:
inserting an automatic back up system into the port of a computer;
the computer scanning and detecting a device connected to the port;
the computer identifying the automatic backup system;
the computer automatically launching a backup procedure to backup its files onto the automatic backup system; and
the computer automatically closing down the backup procedure at the completion of the backup.
